(19) United States
(12) Patent Application Publication
(10) Pub. No.: US 2017/0232379 A1
(43) Pub. Date: Aug. 17, 2017

(54) Glycol Dehydration Unit

(71) Applicant: Paul A. Carmody, Spring, TX (US)

(72) Inventor: Paul A. Carmody, Spring, TX (US)

(21) Appl. No.: 15/435,277

(22) Filed: Feb. 16, 2017

Related U.S. Application Data
(60) Provisional application No. 62/295,825, filed on Feb. 16, 2016.
(60) Provisional application No. 62/444,056, filed on Jan. 9, 2017.
(60) Provisional application No. 62/444,137, filed on Jan. 9, 2017.

(51) Int. Cl. B01D 53/14; B01D 53/26; B01D 53/18; C10L 3/10

(52) U.S. Cl. CPC B01D 53/1425; C10L 3/106; B01D 53/263; B01D 53/18; C10L 2290/12; C10L 2290/541; B01D 2252/2023

(57) ABSTRACT

A glycol dehydration unit includes four subsystems. The glycol contact system, a rich glycol handling system, a rich glycol lifting system and a glycol regeneration system. The rich glycol lifting system lifts the rich glycol from a rich glycol heater to an entry point on a still stahl column and provides for the introduction of stripping gas for the purpose of further removing water from process gas. The glycol dehydration unit uses heretofore undiscovered characteristics of a reboiler and stahl column system.

### CROSS REFERENCE TO RELATED APPLICATIONS

The present Non-Provisional U.S. Patent Application claims priority from Provisional U.S. Patent Application No. 62/295,825 filed Feb. 16, 2016, Provisional U.S. Patent Application No. 62/444,056 filed Jan. 9, 2017, and Provisional U.S. Patent Application No. 62/447,137 filed Jan. 17, 2017.

### STATEMENT REGARDING FEDERALLY SPONSORED RESEARCH OR DEVELOPMENT

The present disclosed apparatus and method in this Non-Provisional U.S. Patent Application was not the subject of federally sponsored research or development.

### BACKGROUND

Liquid desiccants, such as triethylene glycol (TEG), diethylene glycol, and glycerol, are commonly utilized to dehydrate gasses: for example, natural gas. Typically the liquid desiccant requires dehydration in order to enable reuse of the liquid desiccant.

Glycol dehydration units have been available for decades. Many glycol dehydration units have been installed for delivering dehydrated process gas to pipelines. Most of these units are installed for dehydrating less than 10 million standard cubic feet of gas per day (see: Curtis O. Rueter, Kevin S. Fisher, Patrick A. Thompson, Duane B. Meyers, R-BTEX™ Prototype Performance Testing Results, Austin, August 1994, pg. I-26). These glycol dehydration units have become commodity items wherein simple equipment operation and low purchase costs dominate the decision making process when making purchases of glycol dehydration units.

The development of glycol dehydration units matured by the 1960's. An article from 1966 put it this way: “The most effective refinement in the performance of triethylene glycol dehydration units has been in the method of regeneration as indicated in U.S. Pat. No. 3,105,748” (see: Worley, Steve, Twenty Years of Progress with TEG Dehydration, Canadian Natural Gas Processors Association, Calgary, Alberta, Canada, Dec. 3, 1966, pg. 255). That same article included a plot entitled “The Effect of Stripping Gas on TEG Concentration” a version of which is included as FIG. 1. This plot has been modified several times and has been included in many references describing the design of glycol dehydration equipment. This plot has become the standard used those of ordinary skill in the art to determine the number of stahl column equilibrium stages of contact needed to achieve a desired glycol water quality specification.

This plot is being used as of 2016 (see: Sheilen, Michael, editor, Laurance Reid Gas Conditioning Conference 2016 Gas Dehydration Fundamentals, The 66^{th} Laurance Reid Gas Conditioning Conference, 2016, pg. 42). By 1987 the plot, as shown in FIG. 1, taught the use of a stahl column with three equilibrium stages of contact. In 2000 the plot was modified to the teaching of two equilibrium stages of contact but the amount of stripping gas used was increased.

Most glycol dehydration units sold today are similar to the glycol dehydration unit disclosed by U.S. Pat. No. 3,105,748. This type of unit is discussed below.

The glycol gas column is used to absorb water from the process gas and a still attached to the top of a reboiler. A stahl column, named after its inventor, Willi Stahl, is used to strip additional water from the glycol that exits the reboiler. The still, the reboiler, and the stahl column operate as close to atmospheric pressure as possible while avoiding a vacuum. The reboiler typically heats the glycol as close as feasible to the decomposition temperature (for TEG this is about 404 deg F.) with most of the water vaporizing along with some of the glycol. Condensing is required which cools and refluxes the gases with the process intent of condensing the glycol. The water and volatile deleterious substances exit the still column as a vapor.

In prior art systems the glycol stream that exits the reboiler then flows through a second column, which is the stahl column. The stahl column is relatively short (possibly four feet in height) for additional stripping of water from the glycol stream. The stahl column fits in the space between the surge tank and reboiler and may extend into the reboiler or be routed beside it. The stahl column has a glycol stream entering the upper portion of the stahl column. A stripping gas stream enters the bottom portion of the stahl column. The stripping gas stream intimately contacts the downward flowing glycol stream as the stripping gas rises thereby removing more water than the still column and reboiler removed.

In the course of regeneration, the water must be removed from the glycol. Volatile deleterious substances are also removed from the glycol. In addition, natural gas, which has methane as its principle constituent, is often introduced, as something called stripping gas, to the regeneration equipment to aid in improving the effectiveness of the regeneration process.

The simplest solution is to vent the water, the methane, and the deleterious volatile substances into the atmosphere. U.S. Pat. No. 3,105,748 teaches still column vapor venting in the pre-EPA era. Presently, some glycol regeneration units continue to vent the water and volatile deleterious substances along with stripping gas into the atmosphere. When this occurs environmental regulations require compliance reporting and limit the amount of permissible atmospheric venting.

Managing emissions is one area where the industry has made improvements over the prior art since the 1960's. For example, U.S. Pat. No. 6,375,806 discloses high pressure glycol dehydration. A related article also discusses high pressure dehydration (see: Hicks, R., Gallaher, D., and Craig, R. Pressurized reboiler reduces VOC emissions in glycol dehy [sic] systems, Oil & Gas J., Vol 102, Issue 17, May 3, 2004). This advances the prior art in that glycol regeneration at 50 psig has been commercially achieved. Vapors from the still overhead at these pressures are often easily gathered and thus emissions are reduced to the point where reporting becomes unnecessary.

An unmet need remains in the art for a glycol dehydration unit that is simple, can reliably and economically achieve dehydrated process gas, and at the same time minimize emissions into the environment.

### SUMMARY

The disclosed apparatus and method is a glycol dehydration unit that is simple, can reliably and economically achieve dehydrated process gas, and at the same time minimizing emissions into the environment.

Disclosed herein is a glycol gas contactor system in which the lean glycol and wet process gas are introduced into the system. The lean glycol and wet process gas intimately contact one another. Water and volatile deleterious substances from the wet process gas are absorbed into the lean glycol. The wet gas is transformed into dehydrated process gas. The dehydrated process gas exits the system. The lean glycol is transformed into rich glycol. The rich glycol exits the glycol gas contactor system.

In the rich glycol handling system, the flow of rich glycol is controlled by a level control device. This level control device reduces the pressure of the rich glycol which then exits the rich glycol handling system.

A glycol regeneration includes a rich glycol heater, a rich glycol lifting system, a still stahl column, and a system for introducing primary stripping gas.

The rich glycol regeneration system includes a rich glycol heater. The rich glycol heater raises the temperature of the rich glycol. The rich glycol heater also vaporizes a portion of the rich glycol.

The rich glycol lifting system connects from the glycol heater the still stahl column. The rich glycol is lifted to an entry point into the vapor/liquid separator section of the still stahl column. This entry point is at a higher elevation than the liquid level in the rich glycol heater. Liquid and vapor separate in the vapor/liquid separator section of the still stahl column. Water and volatile deleterious substances are separated from rich glycol by condensing in the still portion of the still stahl column.

The stripping gas system introduces primary stripping gas into the still stahl column which removes additional water and volatile deleterious substances. Water and volatile deleterious substances exit from the upper portion of stahl column of still stahl column. The lean glycol exits from the lower portion of the still stahl column and flows into a surge tank to be returned to the glycol gas contactor system.

The disclosed glycol dehydration unit thus reduces the presence of water and volatile deleterious substances in the process gas.

### BRIEF DESCRIPTION OF THE DRAWING FIGURES

A better understanding of the presently disclosed apparatus and method may be had by reference to the drawing figures wherein:

FIG. 1 is a prior art plot entitled “Effect of Stripping Gas on TEG Concentration” which is currently used to determine the number of equilibrium stages of contact of a stahl column and stripping gas rate for a given purity of lean glycol (see background and see paragraph [0050] below);

FIG. 2 is a plot entitled “Stahl Column Sizing Plot” which is to be used to determine the number of equilibrium stages of contact of a stahl column and stripping gas rate for a given glycol water quality specification for the presently disclosed apparatus and method which led to the presently disclosed apparatus and method (see paragraphs [0051] to [0056] below);

FIG. 3 is a schematic drawing of the preferred embodiment of the presently disclosed apparatus and method which includes a rich glycol heater and gas lifting rich glycol apparatus into a still stahl column which was created using the plot in FIG. 2.

### DESCRIPTION OF THE EMBODIMENTS

A still better understanding of the presently disclosed apparatus and method may be had by an understanding of the following terminology which is used repeatedly in the following description of the construction and operation of the presently disclosed apparatus and method.

### Terminology

Dehydrated Process Gas.

Dehydrated process gas is process gas that meets the desired process gas water quality specification.

Gas Lifting.

Gas lifting is the lifting of rich glycol from the elevation of the liquid level of rich glycol entering the rich glycol heater to the elevation where the rich enters the still stahl column wherein the vapors and liquid glycol are lifted as a mixed fluid. The vapors may include startup stripping gas as well as vapors from the glycol.

Glycol.

Glycol includes triethylene glycol, diethylene glycol, glycerol as well as all other types of liquid desiccants. Glycol may also refer to glycol that does not meet the definition of either rich or lean glycol; such glycol is in an intermediate state of regeneration.

Glycol Gas Contactor.

The glycol gas contactor is the contactor in which the wet process gas stream is dehydrated by introducing the lean glycol stream into the upper portion of the glycol gas contactor and then removing the rich glycol from the lower portion of the glycol gas contactor.

Glycol Water Quality Specification.

The glycol water quality specification is the maximum permissible amount of water in the lean glycol that will allow for the manufacture of dehydrated process gas.

Lean Glycol.

Lean glycol is the regenerated glycol stream after water has been removed by the still stahl column.

Lean/Rich Heat Exchanger.

The lean/rich heat exchanger is the exchanger that exchanges heat between the lean glycol stream and the rich glycol stream.

Primary Stripping Gas.

Primary stripping gas is the stripping gas that is introduced into the bottom portion the stahl portion of the still stahl column.

Process Gas.

Process gas is the gas stream requiring dehydration. Process gas is also referred to as wet process gas before dehydration occurs and dehydrated process gas after water is removed from the gas within the glycol gas contactor system.

Process Gas Water Quality Specification.

Process gas water quality specification is the maximum permissible amount of water in the dehydrated process gas. The specification may be set by contract or to meet other requirements. The process gas water quality specification may be changed from time to time.

Reflux Liquid.

Reflux liquid is the liquid manufactured by introducing a reflux water stream in the upper portion of the still portion of the still stahl column. The reflux liquid composition varies as the reflux liquid descends through the still portion of the still stahl column. In the upper portion of the still portion of the still stahl column the reflux liquid will be nearly all water. As the reflux liquid descends the water content will decrease and the glycol content of the reflux liquid will increase.

Reflux Water Stream.

The reflux water stream is the water stream introduced into the upper portion of the still portion of the still stahl column. The reflux water stream, which is nearly pure water, vaporizes and exits the still portion of the still stahl column as a vapor.

Rich Glycol Heater.

The rich glycol heater is the heater that adds the heat needed to regenerate the lean glycol stream.

Rich Glycol.

The rich glycol is the glycol stream which contains the water removed from the glycol gas contactor system and also contains volatile deleterious substances from the intimate contact of the fluids within the glycol gas contactor system.

Rich Glycol Lifting System.

The rich glycol lifting system is a subsystem of the glycol regeneration system and includes the pipe that increases the elevation from the outlet of the rich glycol heater to into the vapor/liquid separator section of the still stahl column. If a pump is used to lift the liquid glycol, separation of vapor from liquid will have been performed upstream of the pump, preferably within the rich glycol heater with the liquid being pumped and then flowing through one pipe into the vapor/liquid separator section of the still stahl column. The separated vapor would flow through another pipe into the vapor/liquid separator section of the still stahl column

Rich Glycol Temperature Set Point.

The rich glycol temperature set point is the temperature to which liquid glycol is heated within the rich glycol heater. This temperature is typically close to the decomposition temperature. The rich glycol temperature set point may be about 400 deg F. for TEG.

Secondary Stripping Gas.

Secondary stripping gas is stripping gas that is introduced into the stahl column portion of the still stahl column at a higher elevation than where the primary stripping gas is introduced into the column. Secondary stripping gas normally has greater water content than is suitable for primary stripping gas.

Startup Stripping Gas.

Startup stripping gas is stripping gas that is introduced into rich glycol to facilitate gas lifting the rich glycol from the elevation of the rich glycol heater to the elevation of the still stahl column. Startup stripping gas is introduced upstream from or into the rich glycol lifting system. Startup stripping gas would normally be utilized for startup of the glycol dehydration unit during times when there is no wet process gas flowing through the glycol gas contactor system. Startup stripping gas may be utilized during normal operation as well as startup operations.

Still Stahl Column.

The still stahl column has three parts. The top section is a refluxed absorber referred to as the still portion of the still stahl column. The middle section is the vapor/liquid separator section of the still stahl column into which rich glycol enters the column which preferably utilizes a chimney tray at the bottom of the section. The bottom section which is a stripper section is referred to as the stahl portion of the still stahl column.

Stripping Gas.

Stripping gas is a gas that is substantially a non-condensable vapor throughout the glycol regeneration system. The process intent is for the stripping gas to be entirely vapor but the stripping gas may include small amounts of condensable substances including hydrocarbons. Such condensation is not an appreciable portion of the stream and rarely exceeds one mole percent of the stream.

Surge Tank.

The surge tank is the tank that allows for surges in flow as some glycol may be held in various portions of the glycol dehydration unit.

Thermosiphon.

A thermosiphon is a heater oriented such that rich glycol stream flows in an upward through the thermosiphon. A thermosiphon combines the function of the rich glycol heater and the rich glycol lifting system into a single unit. Note that for a thermosiphon the liquid level in the rich glycol heater has the meaning of the elevation of inlet of the rich glycol stream as the rich glycol enters rich glycol heater.

Volatile Deleterious Substances.

Volatile deleterious substances are substances, other than water, absorbed into glycol from the process gas as the process gas is transformed from lean glycol to rich glycol within the glycol gas contactor system. These volatile deleterious substances typically include carbon dioxide, volatile organic compounds (VOC's), hazardous air pollutants (HAP's), and as benzene, toluene, ethylbenzene, and xylene (BTEX), hydrogen sulfide and small amounts of other deleterious substances.

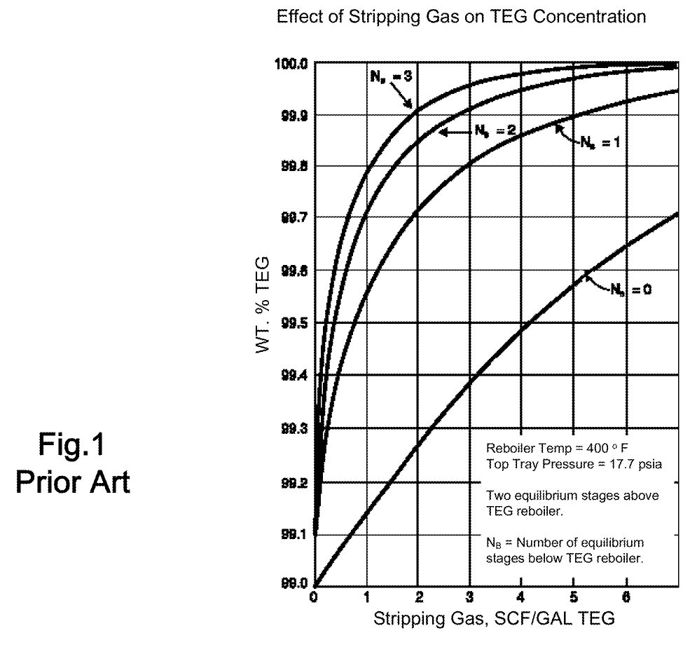

As previously indicated, FIG. 1 is a prior art plot entitled the “Effect of Stripping Gas on TEG Concentration” which is currently used to determine the number of equilibrium stages of contact of a stahl column and stripping gas rate for a given purity of lean glycol. FIG. 1 teaches up to three equilibrium stages of contact. FIG. 1 is based on 17.7 psia and the rich glycol temperature set point is 400 deg F. By using the number of equilibrium stages of contact determined from FIG. 1, those of ordinary skill in the art can then determine the height of the stahl column.

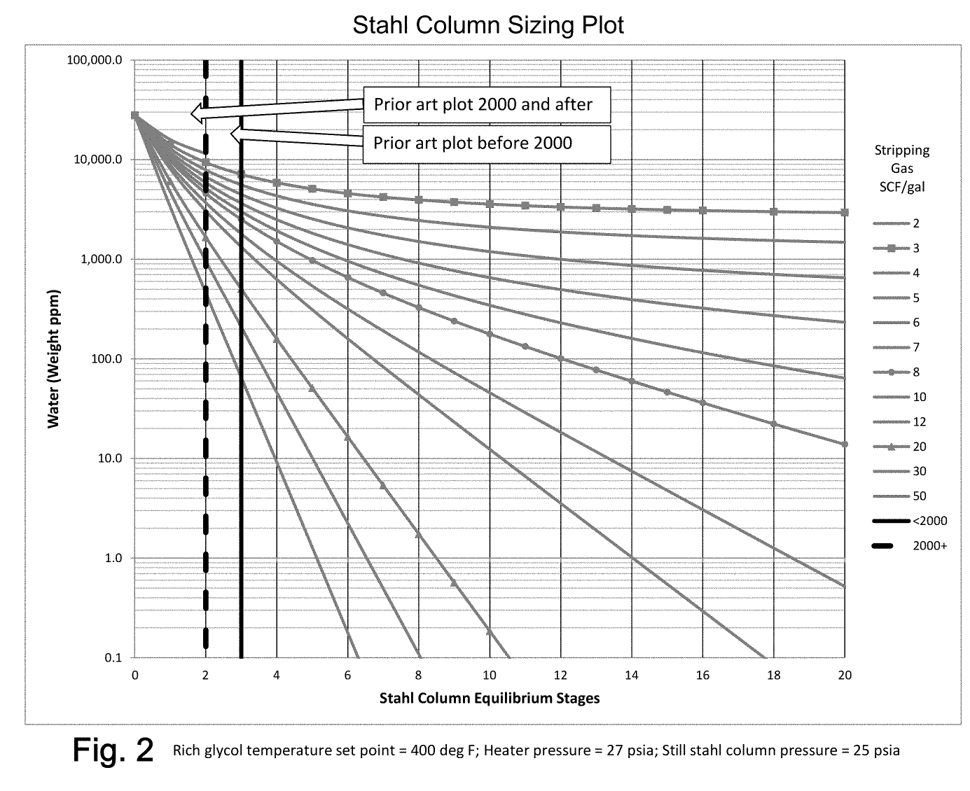

As previously indicated, FIG. 2 is a graphical representation of the discovery that greatly extends the knowledge of the performance of a stahl column and led to the presently disclosed apparatus and method.

FIG. 2 is a plot entitled the “Stahl Column Sizing Plot” which is to be used to determine the number of equilibrium stages of contact of a stahl column and stripping gas rate for a given glycol water quality specification.

FIG. 2 is the solution which led to the preferred embodiment of the presently disclosed apparatus and method. The rich glycol heater operates at 27 psia, the still stahl column operates at 25 psia, and the rich glycol temperature set point is 400 deg F.

FIG. 2 teaches up to 20 stages of equilibrium stages of contact which can be readily expanded past 20 stages with future plots.

FIG. 2 teaches of levels water concentrations in lean glycol as low as 0.1 parts per million by weight water concentration in lean glycol and this limit can be readily extended to lower concentrations with future plots. Future plots can also be readily derived for varying set point temperature and regeneration system pressures.

The use of FIG. 2 is similar to the use of FIG. 1. By using the number of equilibrium stages of contact determined from FIG. 2, those of ordinary skill in the art can then easily determine the height of the stahl column portion of the still stahl column.

### Construction Design and Operation

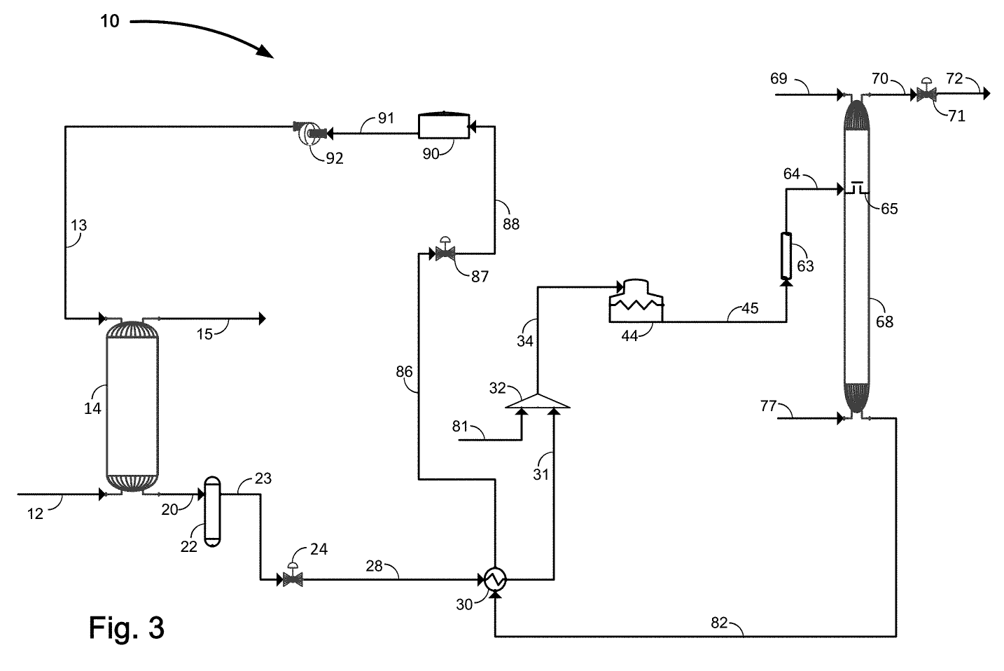

An overview of the construction, design, and operation of the preferred embodiment 10 of the presently disclosed apparatus and method appears in FIG. 3.

In FIG. 3 it may be seen the wet process gas stream 12, usually at more than 200 psig, containing water that is to be substantially removed enters the glycol gas contactor 14 where wet process gas stream 12 mixes intimately with the lean glycol stream 13. This intimate mixing transforms the mixture with the dehydrated process gas stream 15 exiting the glycol gas contactor 14. The lean glycol stream has now been transformed into a rich glycol stream 20 which contains the water from the wet process gas as well as volatile deleterious substances from stream 12. Stream 12 then exits the glycol gas contactor 14.

The rich glycol stream 20 then flows through a filter 22. The rich glycol stream 20 then flows as stream 23 to a level control device 24. The level control device 24 controls the flow. The level control device 24 drops the pressure of stream 23 to the pressure of stream 28. Rich glycol stream 28 flows to the lean/rich heat exchanger 30. The lean/rich heat exchanger 30 raises the temperature of the rich glycol which exits the system as stream 31.

The rich glycol stream 31 flows to junction 32 which mixes the contents of stream 31 with startup stripping gas stream 81 to form stream 34. Stream 34 flows to rich glycol heater 44. This further raises the temperature to the rich glycol temperature set point, which vaporizes a portion of the water, some volatile deleterious substances, and some glycol. The mixed vapor and liquid phases then exit the rich glycol heater 44 as stream 45. Those of ordinary skill in the art will recognize that startup stripping gas stream 81 may be injected upstream from or into the rich glycol lifting system. Startup stripping gas stream 81 could alternatively be introduced directly into rich glycol heater 44 or a startup stripping gas stream 81 could be mixed with stream 45.

The rich glycol lifting system is a subsystem of the glycol regeneration system and includes stream 45, pipe 63 and stream 64. For the preferred embodiment 10, stream 45 consists of mixed vapor and liquid phases which then gas lifts upwards in pipe 63 exiting as stream 64 and which is introduced into the vapor/liquid separator section 65 of the still stahl column 68.

Those of ordinary skill in the art will recognize that a pump could alternately be utilized to lift the liquid glycol phase of rich glycol stream 45. For the pump alternative, startup stripping gas stream 81 would be omitted. Separation of vapor from liquid will have been performed upstream of the pump, preferably within the rich glycol heater 44. The liquid glycol flowing as stream 45, is then pumped through pipe 63 and stream 64 is introduced into the vapor/liquid separator section 65 of still stahl column 68. The vapor phase of rich glycol would now flow through a separate pipe which is introduced into the vapor/liquid separator section 65 of the still stahl column 68.

Those of ordinary skill in the art will recognize that a thermosiphon could alternately be used instead of the gas lifting of preferred embodiment 10. A thermosiphon combines the function of the rich glycol heater 44 and the rich glycol lifting system into a single unit. The thermosiphon replaces the rich glycol heater 44, rich glycol stream 45, and pipe 63. Stream 34 would feed into a thermosiphon which raises the temperature to the rich glycol heater set point while simultaneously gas lifting the rich glycol. Rich glycol stream 64 would now exit the thermosiphon which is introduced into the vapor/liquid separator section 65 of the still stahl column 68.

In addition to stream 64 the still stahl column 68 has two other inlet streams. The two other inlet streams are the primary stripping gas stream 77 and a reflux water stream 69 which enter the still stahl column 68. The two outlet streams from the still stahl column 68 are the still overhead vent stream 70 and the lean glycol stream 82.

An alternative configuration for still stahl column 68 would include installing a chimney tray to remove liquid, between the still portion of the still stahl column 68 and the vapor/liquid separator section 65 of the still stahl column 68. The liquid from this chimney tray would be directed at a lower elevation into junction 32 and then become a part of stream 34.

Primary stripping gas stream 77 may be taken from the dehydrated process gas stream 15 which will be reduced in pressure optionally heated. It is necessary that primary stripping gas stream 77 has low enough water content to transform the glycol into lean glycol stream 82. Dehydrated process gas 15 will typically be suitable for use as primary stripping gas stream 77. If fuel gas is available fuel gas is often utilized as the source of the primary stripping gas stream 77.

Primary stripping gas stream 77 is introduced into the bottom portion of the stahl portion of still stahl column 68. Stream 77 then flows upwardly through the stahl column portion of the still stahl column 68. Primary stripping gas stream 77 intimately contacts liquid glycol in a counter current fashion and removes water from the liquid glycol stream which makes the glycol stream ever drier as the liquid glycol descends through to the bottom portion of the stahl column portion of the still stahl column 68 exiting as a lean glycol stream 82. Optionally, a secondary stripping gas stream may be introduced into the stahl portion of the still stahl column 68 at a higher elevation than where primary stripping gas 77 is introduced. As the primary stripping gas stream ascends through the stahl column portion of the still stahl column 68 the primary stripping gas 77 is transformed as water, volatile deleterious substances, and some of the glycol from the glycol stream are absorbed.

As the primary stripping gas stream 77 that also contains water and volatile deleterious substances ascends into the vapor/liquid separator section 65 of the still stahl column 68 mixing occurs with vapors from rich glycol stream 64 that separate the from the liquid phase in the vapor/liquid separator section 65 of the still stahl column 68. This vapor stream continues into the still portion of the still stahl column 68 Cooling of the vapor occurs as the reflux liquid descending from the upper portion of the still stahl column 68 intimately contacts the vapor stream.

The reflux liquid is manufactured by introducing a reflux water stream 69 into the upper portion of the still portion of the still stahl column 68. Stream 69, which is nearly pure water, vaporizes. This vaporizing of stream 69 provides the cooling needed to condense nearly all of the glycol from the vapors rising in the still portion of the still stahl column 68. The still overhead vent gas stream 70 consists of nearly all of the primary stripping gas stream 77 constituents plus the water from the reflux water stream 69 plus the majority of the water from stream 64 plus nearly all of the volatile deleterious substances from the stream 64 but almost no glycol from stream 64. There are a number of different ways of providing the needed condensing duty well known to those of ordinary skill in the art. One common method is to install a condenser that utilizes the rich glycol stream 23 to provide the condenser duty.

The still overhead vent stream 70 exits the still portion of still stahl column 68 and flows through optional pressure control device 71 which provides back pressure to control the pressure of the glycol regeneration system. For the preferred embodiment that pressure would be 25 psia. Stream 72 is a vapor stream that exits the glycol regeneration system and can be condensed utilizing techniques familiar to those of ordinary skill in the art. Once condensed, the gas becomes suitable for compression which reduces emissions. Condensing water from stream 72 could provide a suitable source for reflux water stream 69.

After lean glycol stream 82 exits the still stahl column 68 lean glycol stream 82 flows through lean/rich heat exchanger 30. The heat exchange with rich glycol reduces the temperature of the lean glycol stream 82. The cooled lean glycol stream 86 exits the lean/rich exchanger. Stream 86 flows through level control device 87. The level control device 87 controls the liquid level in stahl portion of the still stahl column 68. Stream 88 exits from the level control device 87 and flows to surge tank 90. From surge tank 90 lean glycol stream 91 flows to a lean glycol pump 92 which increases the pressure such that stream 13 may enter the glycol gas contactor system.

Those of ordinary skill in the art will understand that while the disclosed apparatus and method have been disclosed according to its preferred and other embodiments, numerous combinations and arrangements of the disclosed apparatus and method may be made without departing from the foregoing description. Such combinations and arrangements shall fall within the scope and meaning of the appended claims.

I claim:

1. A glycol dehydration unit comprising:
a glycol gas contactor system wherein:
lean glycol is introduced into said glycol gas contactor system;
wet process gas is introduced into said glycol gas contactor system;
said glycol gas contactor system being constructed and arranged so that said lean glycol and said wet process gas intimately contact one another so that absorption of water and volatile deleterious substances from said wet process gas which is transformed into dehydrated process gas which exits said glycol gas contactor system and said lean glycol is transformed into rich glycol which exits said glycol gas contactor system;
a rich glycol handling system wherein the flow of said rich glycol is controlled by a level control device which level control device reduces the pressure of said rich glycol as said rich glycol exits said rich glycol handling system;
a glycol regeneration system including:
a rich glycol heater which raises the temperature of said rich glycol and vaporizes a portion of said rich glycol, and separates vapor and liquid phases of said rich glycol;
a rich glycol lifting system which connects from said rich glycol heater to a still stahl column and pumps said liquid phase of said rich glycol to an entry point into the vapor/liquid separator section of said still stahl column and at a higher elevation than the liquid level in said rich glycol heater;
said rich glycol lifting system which connects from said rich glycol heater to said still stahl column and flows said vapor phase of said rich glycol to an entry point into said vapor/liquid separator section of said still stahl column and at a higher elevation than the liquid level in said rich glycol heater;
the liquid and vapor separated in said vapor/liquid separator section of said still stahl column and then said water and said volatile deleterious substances separate from said rich glycol by condensing in the still portion of said still stahl column;
a chimney tray between said still portion of said still stahl column and said vapor/liquid separator section of said still stahl column connected at a lower elevation to a junction upstream of said rich glycol heater;
the stahl portion of said still stahl column has more than three equilibrium stages of contact;
a system for introducing primary stripping gas into said stahl portion of said still stahl column to remove additional water and volatile deleterious substances which exit said still stahl column and said lean glycol exits said still stahl column and flows into a surge tank to be returned to said glycol gas contactor system;
a secondary stripping gas stream is introduced into said stahl portion of said still stahl column at an elevation higher than said primary stripping gas is introduced;
whereby the presence of water and volatile deleterious substances are reduced.

2. A method of dehydrating glycol comprising:
utilizing a glycol gas contactor system wherein:
introducing lean glycol into said glycol gas contactor system;
introducing process gas into said glycol gas contactor system;
Constructing and arranging said glycol gas contactor system so that said lean glycol and said wet process gas intimately contact one another so that absorption of water and volatile deleterious substances from said wet process gas which is transformed into dehydrated process gas which exits said glycol gas contactor system and said lean glycol is transformed into rich glycol which exits said glycol gas contactor system;
utilizing a rich glycol handling system wherein the flow of said rich glycol is controlled by a level control device which level control device reduces the pressure of said rich glycol as said rich glycol exits said rich glycol handling system;
utilizing glycol regeneration system including:
raising the temperature of said rich glycol by using a rich glycol heater which vaporizes a portion of said rich glycol, and separates vapor and liquid phases of said rich glycol;
utilizing a rich glycol lifting system which connects from said rich glycol heater to a still stahl column and pumps said liquid phase of said rich glycol to an entry point into the vapor/liquid separator section of said still stahl column and at a higher elevation than the liquid level in said rich glycol heater;
utilizing said rich glycol lifting system which connects from said rich glycol heater to said still stahl column and flows said vapor phase of said rich glycol to an entry point into said vapor/liquid separator section of said still stahl column and at a higher elevation than the liquid level in said rich glycol heater;
separating the liquid and vapor in said vapor/liquid separator section of said still stahl column and then said water and said volatile deleterious substances separate from said rich glycol by condensing in the still portion of said still stahl column;
removing liquid using a chimney tray between said still portion of said still stahl column and said vapor/liquid separator section of said still stahl column connected at a lower elevation to a junction upstream of said rich glycol heater;
contacting occurs across more than three equilibrium stages of the stahl portion of said still stahl column;
utilizing a system for introducing primary stripping gas into said stahl portion of said still stahl column to remove additional water and volatile deleterious substances which exit said still stahl column and said lean glycol exits said still stahl column and flows into a surge tank to be returned to said glycol gas contactor system;
introducing a secondary stripping gas stream into said stahl portion of said still stahl column at an elevation higher than said primary stripping gas is introduced;
whereby the presence of water and volatile deleterious substances are reduced.

3. A glycol dehydration unit comprising:
a glycol gas contactor system wherein:
lean glycol is introduced into said glycol gas contactor system;
wet process gas is introduced into said glycol gas contactor system;
said glycol gas contactor system being constructed and arranged so that said lean glycol and said wet process gas intimately contact one another so that absorption of water and volatile deleterious substances from said wet process gas which is transformed into dehydrated process gas which exits said glycol gas contactor system and said lean glycol is transformed into rich glycol which exits said glycol gas contactor system;
a rich glycol handling system wherein the flow of said rich glycol is controlled by a level control device which level control device reduces the pressure of said rich glycol as said rich glycol exits said rich glycol handling system;
a glycol regeneration system including:
a rich glycol heater which both raises the temperature of said rich glycol and vaporizes a portion of said rich glycol;
a rich glycol lifting system which connects from said rich glycol heater to a still stahl column and lifts said rich glycol to an entry point into the vapor/liquid separator section of said still stahl column and a higher elevation than the liquid level in said rich glycol heater wherein liquid and vapor separated in said vapor/liquid separator section of said still stahl column and then said water and said volatile deleterious substances separate from said rich glycol by condensing;
a system for introducing primary stripping gas into the stahl portion of said still stahl column to remove additional water and volatile deleterious substances which exit said still stahl column and said lean glycol exits said still stahl column and flows into a surge tank to be returned to said glycol gas contactor system;
whereby the presence of water and volatile deleterious substances in are reduced.

4. The glycol dehydration unit of claim 3 wherein said rich glycol lifting system includes gas lifting.

5. The glycol dehydration unit of claim 4 wherein a startup stripping gas stream is introduced upstream from or into said rich glycol lifting system

6. The glycol dehydration unit of claim 3 wherein said rich glycol lifting system includes a pump.

7. The glycol dehydration unit of claim 3 wherein said rich glycol heater and said rich glycol lifting system are combined into a thermosiphon.

8. The glycol dehydration unit of claim 7 wherein a startup stripping gas stream is introduced upstream from said thermosiphon

9. The glycol dehydration unit of claim 3 wherein said stahl portion of said still stahl column has more than three equilibrium stages of contact.

10. The glycol dehydration unit of claim 3 wherein the glycol regeneration system includes a chimney tray between said still portion of said still stahl column and said vapor/liquid separator section of said still stahl column and connected at a lower elevation to a junction upstream from said rich glycol heater.

11. The glycol dehydration unit of claim 3 wherein a secondary stripping gas stream is introduced into said stahl portion of said still stahl column at an elevation higher than said primary stripping gas is introduced.

12. A method of dehydrating glycol comprising the steps of:
utilizing a glycol gas contactor system:
introducing lean glycol into said glycol gas contactor system;
introducing process gas into said glycol gas contactor system;
Constructing and arranging said glycol gas contactor system so that said lean glycol and said wet process gas intimately contact one another so that absorption of water and volatile deleterious substances from said wet process gas which is transformed into dehydrated process gas which exits said glycol gas contactor system and said lean glycol is transformed into rich glycol which exits said glycol gas contactor system;
utilizing a rich glycol handling system wherein the flow of said rich glycol is controlled by a level control device which level control device reduces the pressure of said rich glycol as said rich glycol exits said rich glycol handling system;
utilizing glycol regeneration system including:
raising the temperature of said rich glycol by using a rich glycol heater which vaporizes a portion of said rich glycol;
utilizing a rich glycol lifting system which connects from said rich glycol heater to a still stahl column and lifts said rich glycol to an entry point into the vapor/liquid separator section of said still stahl column and a higher elevation than the liquid level in said rich glycol heater wherein liquid and vapor separated in said vapor/liquid separator section of said still stahl column and then said water and said volatile deleterious substances separate from said rich glycol by condensing;
utilizing a system for introducing primary stripping gas into the stahl portion of said still stahl column to remove additional water and volatile deleterious substances which exit said still stahl column and said lean glycol exits said still stahl column and flows into a surge tank to be returned to said glycol gas contactor system;
whereby the presence of water and volatile deleterious substances in are reduced.

13. The method of claim 12 wherein gas lifting is utilized within said rich glycol lifting system.

14. The method of claim 13 introducing a startup stripping gas stream upstream from or into said rich glycol lifting system

15. The method of claim 12 wherein pumping is utilized within said rich glycol lifting system.

16. The method of claim 12 wherein heating and gas lifting of said rich glycol heater and rich glycol lifting system are combined by using a thermosiphon.

17. The method of claim 16 introducing a startup stripping gas stream upstream of said thermosiphon

18. The method of claim 12 wherein contacting occurs across more than three equilibrium stages within said stahl portion of said still stahl column.

19. The method of claim 12 within the glycol regeneration system removing liquid using a chimney tray between said still portion of said still stahl column and said vapor/liquid separator section of said still stahl column and connected at a lower elevation to a junction upstream from said rich glycol heater.

20. The method of claim 12 introducing a secondary stripping gas stream into said stahl portion of said still stahl column at an elevation higher than introduction point of said primary stripping gas.
